(19) United States
(12) Patent Application Publication
(10) Pub. No.: US 2007/0143529 A1
(43) Pub. Date: Jun. 21, 2007

(54) Apparatus and method for PC security and access control

(76) Inventor: Steven V. Bacastow, Cumming, GA (US)

Correspondence Address: Steven V. Bacastow, 1330 Grove Park Lane, Cumming, GA, 30041, US

(21) Appl. No.: 11/255,495

(22) Filed: Oct. 21, 2005

Related U.S. Application Data
(60) Provisional application No. 60/675,637, filed on Apr. 28, 2005.

(51) Int. Cl. G06F 12/00; G06F 13/00

(52) U.S. Cl. 711/103; 711/115

(57) ABSTRACT

An apparatus and method for configuring, altering, controlling, securing, and extending the processing capability and functionality of PCs using a nonvolatile memory device using software and data carried within the device.

### RELATED APPLICATION

This application claims the benefit of priority of U.S. provisional application Ser. Nos. 60/675,637 filed Apr. 28, 2005 which are relied on and incorporated herein by reference.

### COPYRIGHT NOTICE

A portion of the disclosure of this patent document may contain material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### FIELD OF THE INVENTION

The present invention relates to an apparatus and method for enhancing the functionality and security personal computers through the use of a portable nonvolatile memory device using software and data carried within the device.

### BACKGROUND OF THE INVENTION

In recent years the number of personal computer users has risen dramatically and including corporate users and children. Consumers and businesses are increasingly concerned about protecting the information stored on these computers and limiting access to authorized users. In addition, parents are concerned about the programs, data, and websites that their children are exposed to.

Conventional methods for limiting access to data, programs, and web sites are largely based on controls enforced by software which is resident either on the personal computer or file servers, or in some cases both. While these methods can be effective in limiting certain unauthorized access, there is a need for greater control than is currently available. This is true particularly in light of the increased focus on internal controls in public companies and in recognition of the increasing burden on parents to protect their children from internet predators and other unhealthy content.

Therefore, a need exists for an apparatus and method that addresses these shortcomings in the prior art by utilizing the new capabilities provided through USB technology.

### SUMMARY OF THE INVENTION

The present invention answers these needs by providing an apparatus and method for limiting access to programs, data, and web sites using a nonvolatile memory device using software and data carried within the device.

According to the present invention design, a portable housing is provided with nonvolatile memory inside. An interface is provided on the housing for communication between the nonvolatile memory and personal computer. Software and configuration data are loaded into the nonvolatile memory that comprises a series of utilities for discrete functions. The software application can be loaded into the nonvolatile memory by the manufacturer, or by the user via a CD-ROM, the Internet, or other suitable means.

Because the software ‘security application’ and configuration data ‘user specific attributes’ reside on the removable storage device and not on the PC, the present invention may be used to inter-operate with multiple PCs. The present invention is also based on the well established security precept that the best security is based on “something that you know” in combination with “something that you have”.

It is thus an advantage of the present invention to provide an apparatus and method for defining security controls which are portable and remain with the user as opposed to a solution that resides simply within the PC. To this end, the present invention is highly portable, operates independently of any particular PC, and is compatible with a wide variety of PC and operating systems.

Embodiments of the present invention are described below by way of illustration. Other approaches to implementing the present invention and variations of the described embodiments may be constructed by a skilled practitioner and are considered within the scope of the present invention.

### BRIEF DESCRIPTION OF THE DRAWINGS

FIG. 1 is an overview of the primary components which would be required to support all of the invention embodiments. Components include: (1) Removable USB Flash Memory Device; (2) USB Enabled PC (3) Dial-up or High-speed connection; (4) Host Processor; (5) File Server.

FIG. 2 is an overview of the basic required components which would be required to support a limited set of the invention embodiments. Components include: 1) Removable USB Flash Memory Device; (2) USB Enabled PC.

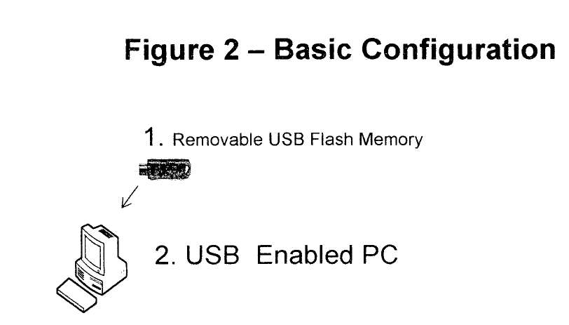

### DETAILED DESCRIPTION OF THE INVENTION

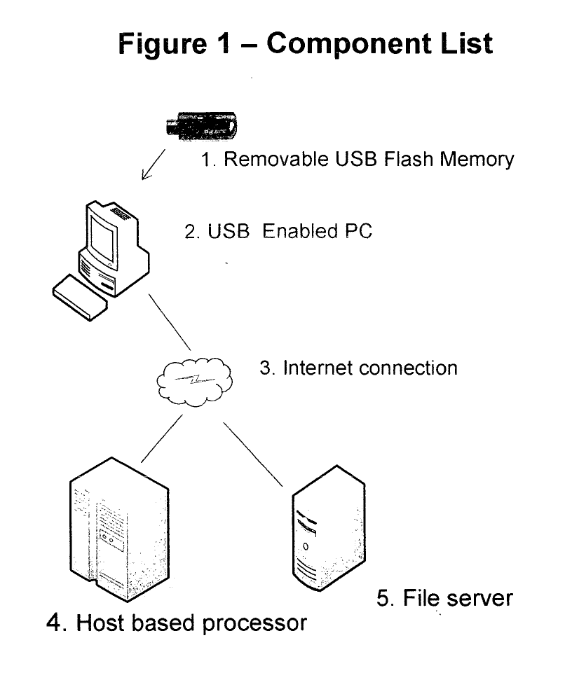

An embodiment of the invention allows for the secure storage of any persistent data onto [FIG. 1: Removable USB Flash Memory Device] related to PC access control and security.

An embodiment of the invention allows for the creation of authorized users and passwords for the specific PCs. Access to applications, approved web sites and data and would therefore require the invention [FIG. 1: Removable USB Flash Memory Device] to be connected to the PC [FIG. 1: USB Enabled PC] prior to use and during use. Because this embodiment will also serves to control the functionality of the PC [FIG. 1: USB Enabled PC] for specific users it therefore functions as a ‘smart key’ to this PC. For example, in connection with this embodiment, a specific child may be permitted to access a limited set of approved programs, files, directories, and web sites while another child may be permitted access to a broader range of programs, data, and web sites. Each child would possess a unique security device that contains their specific privileges.

An embodiment of the invention allows rules to be established for each authorized user which limit access to programs, data, web sites, and servers based on the time of day and or day of the week and by PC ID.

An embodiment of the invention facilitates the protection of files and data stored on the PC [FIG. 1: USB Enabled PC] as well as the removable storage device [FIG. 1: Removable USB Flash Memory Device] through the use of an encryption method which is compliant with current industry security standards (i.e. 128 bit). In connection with this embodiment, encrypted data (specified files and folders stored on the PC) would only be viewable to the authorized user, when the “key” is inserted into the PC and not viewable when the key [FIG. 1: Removable USB Flash Memory Device] is removed.

An embodiment of the invention allows for the configuration of a virtual private network (VPN) or similar secure network over the [FIG. 1: Dial-up of High-speed Internet connection] to facilitate authentication to the network's processor [FIG. 1: Host Processor] or [FIG. 1: File Server]. In connection with this embodiment, a secure token, digital certificate, encryption key or other unique identifier is permanently stored on the USB device [FIG. 1: Removable USB Flash Memory Device] and released to the network to authenticate each session and, or message. As a result, the network connection is only possible when the “key”, [FIG. 1: Removable USB Flash Memory Device is inserted into the PC.

Having thus described the invention in detail, it should be apparent that various modifications and changes may be made without departing from the spirit and scope of the present invention. Consequently, these and other modifications are contemplated to be within the spirit and scope of the following claims.

We claim:

1. An apparatus for extending the security and access control capabilities of a PC including:
a. a portable housing;
b. nonvolatile memory within the housing;
c. an interface on the housing for communication between the nonvolatile memory and the PC; and
d. a software application in the nonvolatile memory comprising a series of utilities designed to perform specific functions;
e. a data repository in the nonvolatile memory to store all required data to support software functions.

2. An apparatus as defined in claim 1, wherein the interface is a universal serial bus connector.

3. A method for the apparatus as defined in claim 1, wherein the security and access control applications may be executed directly from the nonvolatile memory.

4. A method for the apparatus as defined in claim 1, wherein the security and access control software can be configured to function based on the needs of a specific user or corporation.

5. A method for the apparatus as defined in claim 1, wherein the security and access control software can be configured and operate (without a connection with a central system) to function based on the needs of a specific user or corporation.

6. A method for the apparatus as defined in claim 1, that can function as a portable access control and security mechanism for a single PC.

7. A method for the apparatus as defined in claim 1, that can function as a portable access control and security mechanism for multiple PCs.

8. A method for the apparatus as defined in claim 1, that can limit access to files and folders based on the authority level defined for each authorized user.

9. A method for the apparatus as defined in claim 1, that can limit access to programs based on the authority level defined for each authorized user.

10. A method for the apparatus as defined in claim 1, that can limit access to web sites based on the authority level defined for each authorized user.

11. A method for the apparatus as defined in claim 1, that can limit access to data, programs, and web sites based on the day and time ranges defined for each authorized user.

12. An apparatus as defined in claim 1, that can serve as a functional key which unlocks the PC when connected and locks the PC when unconnected.

13. A method for the apparatus as defined in claim 1, that can serve as an access control mechanism to authenticate approved users when the devise is initially connected based on secret information that is entered by the user and matched with information stored in the device.

14. A method for the apparatus as defined in claim 1, that can serve as an access control mechanism to limit the functions that can be performed by authenticated users when connected to a central or remote host computer system based on each approved user's profile.

15. A method for the apparatus as defined in claim 14, that can store and release data that will serve to authenticate a communication session with a central or remote host processor.

16. A method for the apparatus as defined in claim 14 that can store and release data that will serve to authenticate each message sent to a central or remote host processor.
